(19) United States
(12) Patent Application Publication
(10) Pub. No.: US 2026/0159115 A1
(43) Pub. Date: Jun. 11, 2026

(54) Traffic Signal Recognition and Driver Alert Device

(71) Applicant: Keith Loewy, Duluth, GA (US)

(72) Inventor: Keith Loewy, Duluth, GA (US)

(21) Appl. No.: 19/414,373

(22) Filed: Dec. 10, 2025

Related U.S. Application Data
(60) Provisional application No. 63/730,245, filed on Dec. 10, 2024.

(51) Int. Cl. B60W 50/16; B60W 50/14; G06V 10/56; G06V 20/58

(52) U.S. Cl. CPC B60W 50/16; G06V 10/56; G06V 20/584; B60W 2050/143; B60W 2420/403; B60W 2555/60

(57) ABSTRACT

A traffic light detection and driver alert device for detecting the transition from a red traffic signal to a green traffic signal to alert a driver to move the vehicle. The device can be installed in a front grille of an automobile and includes a plurality of image sensors for capturing traffic light emittance and colors of traffic signals in front and overhead of the automobile. The device includes an image processor to detect the transition from a red traffic signal to a green traffic signal. The device is coupled to a speaker and a vibration module for generating an audible alert and a vibration alert to alert the driver of the automobile to the green light. The vibration module can be installed in the driver's seat and the speaker is inside the automobile. The alerts can be selectively actuated by a user as per the preferences of the user.

### CROSS-REFERENCE TO RELATED APPLICATION

The present application claims priority to, and the benefit of, U.S. Provisional Application No. 63/730,245, which was filed on Dec. 10, 2024, and is incorporated herein by reference in its entirety.

### FIELD OF THE INVENTION

The present invention generally relates to the field of traffic signal detection and alert systems for drivers. More specifically, the present invention relates to a novel device for an automobile to notify the driver of a stop light turning from red to green. The device identifies the transition of a red traffic signal to a green traffic signal to notify a driver with an audible notification and/or a vibration in the driver's seat. The device detects traffic lights in an intersection in front of the vehicle and notifies the driver. The device can be integrated or retrofitted as an aftermarket device in automobiles. Accordingly, the present disclosure makes specific reference thereto. Nonetheless, it is to be appreciated that aspects of the present invention are also equally applicable to other like applications, devices, and methods of manufacture.

### BACKGROUND

By way of background, red lights are important in traffic control to prevent accidents and keep drivers, pedestrians, and cyclists safe. Red lights signal drivers to stop their vehicles and wait for the light to turn green before proceeding. Red lights are especially important at intersections, where vehicles and pedestrians are crossing each other's paths. Red lights also help to improve traffic flow by coordinating the movement of vehicles at intersections.

When drivers approach a red traffic light and come to a stop, drivers often shift their attention away from the road for several reasons, including boredom, and impatience, and they generally engage in other activities such as talking to other passengers, operating a smartphone, and more. As a result, when the traffic light changes to green, drivers may not notice immediately. Some drivers even turn off their vehicle's engine to save fuel or reduce emissions, while some vehicles autonomously turn off the vehicle's engine, which can further delay their reaction to the green light.

When one or more drivers fail to notice that the light has turned green and do not move promptly, the cars behind the leading car are also delayed, creating a backlog of vehicles waiting to proceed through the intersection. This may result in traffic congestion, which can lead to delays for all drivers in the area. Currently, there exists no system or device which can instantly and automatically notify drivers that a stop light has turned green. People and traffic regulation authorities desire a device to notify drivers of the traffic light turning green to reduce traffic congestion and enhance road safety.

Therefore, there exists a long-felt need in the art for a notification device that provides a notification to a driver when a red light turns green. Additionally, there is a long-felt need in the art for a stop light sensor device to enhance driver awareness and responsiveness to traffic lights by providing a notification when a red light turns green. Moreover, there is a long-felt need in the art for a traffic light sensor device that be integrated into new vehicles during manufacturing or can be installed as an aftermarket device. Further, there is a long-felt need in the art for a sensor device that addresses a common issue of drivers not promptly reacting to green lights. Furthermore, there is a long-felt need in the art for a stop light sensor device that monitors traffic lights and activates a notification when the traffic light changes from red to green. Also, there is a long-felt need in the art for a sensor device installed in a vehicle that provides an audible alert and/or triggers a vibration in the driver's seat when the light turns from red to green. Finally, there is a long-felt need in the art for a stop light sensor device that prevents distracted drivers from sitting in their vehicle at a green light, thus improving traffic flow and roadway safety.

The subject matter disclosed and claimed herein, in one embodiment thereof, comprises an automated traffic signal recognition and driver notification device. The device can be installed in the front grille of an automobile for detecting a traffic light in front of the automobile and detecting the transition from a red signal to a green signal. The device includes a plurality of image sensors configured to capture and recognize colors and specific patterns of traffic lights, an image processor to detect the transition from the red signal to the green signal, a microprocessor to activate one or both of a speaker and a vibration module to provide an alert to a driver of the automobile when the traffic light turns green. The device is coupled to both the speaker and the vibration module using a wireless or a wired connection. The vibration module is embedded in the driver's seat and the speaker is disposed inside the automobile.

In this manner, the traffic signal recognition and driver notification device of the present invention accomplishes all of the foregoing objectives and provides users with a sensor capable of notifying drivers that a stop light has turned green. The device can be installed in a vehicle grille during manufacturing or as an aftermarket attachment and sounds an audible alert or triggers a vibration in the driver's seat when the traffic light in the front of the vehicle turns from red to green. The device prevents distracted drivers from sitting in their vehicle at a green light, improving traffic flow and roadway safety.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated traffic signal recognition and driver notification device. The device includes a plurality of image sensors configured to capture and recognize colors and specific patterns of traffic lights, a mounting system for installation into the front grille of an automobile, an alert mechanism to provide an alert to a driver of the automobile when a traffic light in front of the automobile turns green, wherein the alert mechanism utilizes data obtained from the image sensors to determine the state of the traffic light.

In yet another embodiment, an automated traffic signal recognition and driver notification device is disclosed. The device includes a waterproof and sealed housing, a plurality of image sensors, an image processor with image processing algorithms to analyze real-time videos and images captured by the image sensors, wherein the algorithms recognize specific patterns and colors of traffic lights, an embedded, rechargeable, and replaceable battery pack, and a microprocessor configured to activate one or both of an audible notification and vibration notification upon detection of the transition from a red traffic light to a green traffic light by the device, the audible notification includes playing an alert sound inside the automobile and the vibration notification is generating a vibration in a driver's seat.

In a further embodiment of the present invention, an automated traffic signal recognition and driver notification system for vehicles is disclosed. The system comprising a device installed on the front grille of a vehicle, the device is coupled to a speaker and a vibration module, the speaker is housed within the vehicle, and the vibration module can be installed in the driver's seat of the vehicle. The device includes a plurality of image sensors for capturing traffic light emittance, and an image processor for detecting the transition from the red signal to the green signal. A microprocessor is configured to activate an audible notification through the speaker and initiates the vibration of the driver seat using the vibration module upon detection of the transition.

In another aspect of the present invention, a method for providing traffic signal alerts to a driver using a traffic signal alert system is described. The method includes the steps of setting user-defined alert parameters and configuration settings using a controlling device, detecting a transition from a red traffic signal to a green traffic signal in a traffic light positioned in front of the vehicle using a traffic signal detection device, providing at least one of audible and vibration alerts to the driver in response to the detection of the transition, detecting vehicle motion using after the transition from the red traffic signal to the green traffic signal, if no vehicle motion is detected, continuing to provide alerts to warn the driver of the green traffic signal and if the vehicle motion is detected, deactivating the alerts.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the stop light sensor of the present invention equipped in a vehicle in accordance with the disclosed structure;

FIG. 2 illustrates an isolated perspective view of one potential embodiment of the stop light sensor of the present invention in accordance with the disclosed structure;

FIG. 3 illustrates a functional block diagram depicting the generation of the audible and vibration notification to alert a driver of a green traffic light in accordance with the disclosed structure;

FIG. 4 illustrates a perspective view showing a field of view of the traffic signal recognition and driver notification device for detecting the transition from a red light to a green light in accordance with the disclosed structure;

FIG. 5 illustrates an exemplary user interface of a monitoring device for controlling and configuring the automated traffic signal recognition and driver notification system of the present invention in accordance with the disclosed architecture; and

FIG. 6 illustrates a flow chart depicting a process of working of the system and the device to provide alerts to a driver in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a notification device that provides a notification to a driver when a red light turns green. Additionally, there is a long-felt need in the art for a stop light sensor device to enhance driver awareness and responsiveness to traffic lights by providing a notification when a red light turns green. Moreover, there is a long-felt need in the art for a traffic light sensor device that can be integrated into new vehicles during manufacturing or can be installed as an aftermarket device. Further, there is a long-felt need in the art for a sensor device that addresses a common issue of drivers not promptly reacting to green lights. Furthermore, there is a long-felt need in the art for a stop light sensor device that monitors the traffic light and activates a notification when the traffic light changes from red to green. Also, there is a long-felt need in the art for a sensor device installed in a vehicle that provides an audible alert or triggers a vibration in the driver's seat when the light turns from red to green. Finally, there is a long-felt need in the art for a stop light sensor device that prevents distracted drivers from sitting in their vehicle at a green light, thus improving traffic flow and roadway safety.

The present invention, in one exemplary embodiment, is a method for providing traffic signal alerts to a driver. The method includes the steps of detecting a transition from a red traffic signal to a green traffic signal in a traffic light positioned in front of the vehicle using a traffic signal detection device, providing at least one audible and vibration alert to the driver in response to the detection of the transition, detecting vehicle motion using after the transition from the red traffic signal to the green traffic signal, if no vehicle motion is detected, continuing to provide alerts to warn the driver of the green traffic signal and if the vehicle motion is detected, deactivating the alerts.

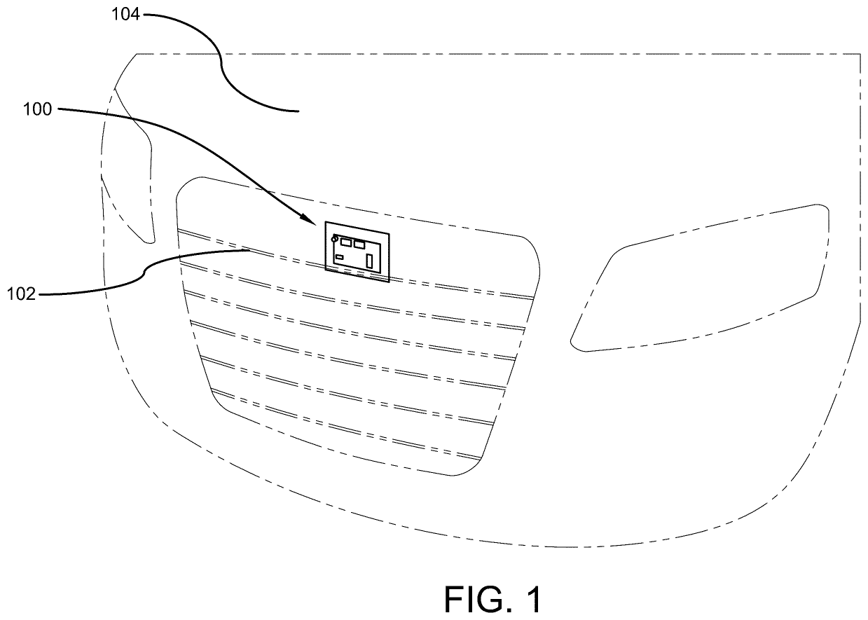

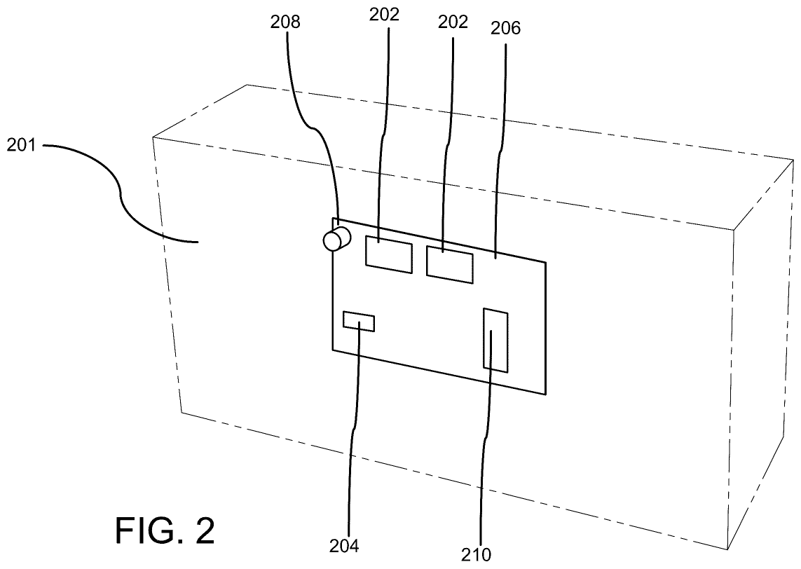

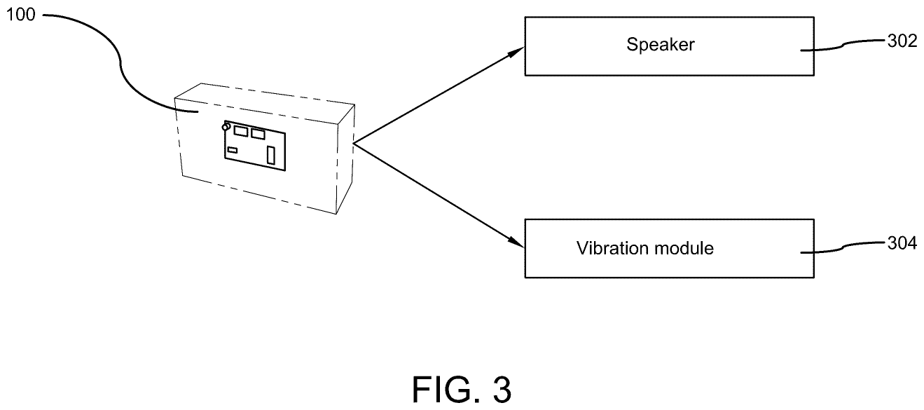

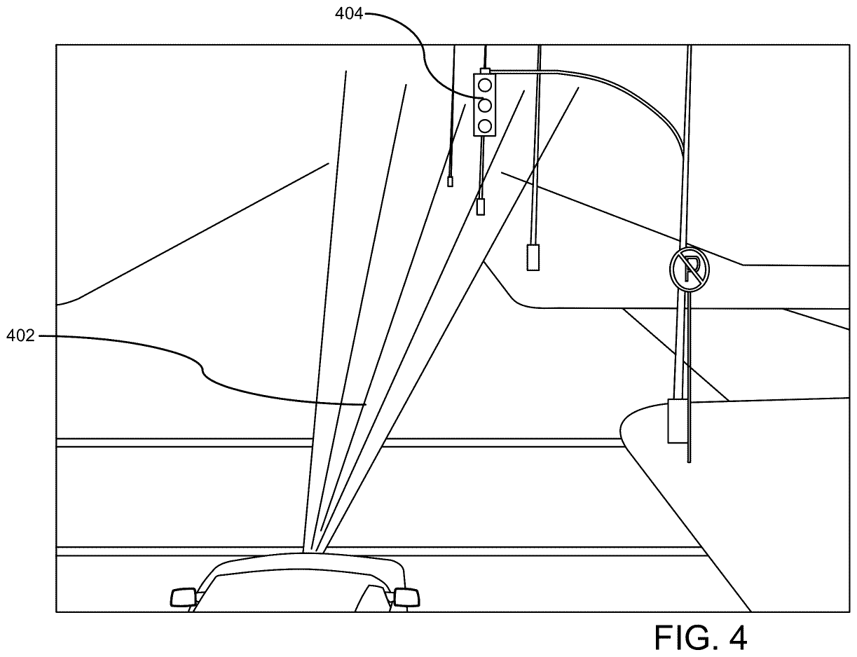

Referring initially to the drawings, FIG. 1 illustrates a perspective view of the stop light sensor of the present invention installed in a front grille of a vehicle in accordance with the disclosed structure. The stop light sensor 100 is designed to be installed in the front grille 102 of an automobile 104 using a mounting mechanism such as an adhesive, mechanical fastener, and any other similar fastener. The sensor 100 provides an alert to a driver of the automobile 104 when a traffic light in front of the automobile 104 turns green as described in FIGS. 3 and 4. More specifically, the sensor device 100 has a plurality of image sensors as illustrated in FIG. 2 to capture and recognize colors and specific patterns of traffic lights. The stop light sensor 100 can be integrated into the automobile 104 during manufacturing of the automobile 104 and can also be used as an aftermarket accessory with existing vehicles.

FIG. 2 illustrates an isolated perspective view of one potential embodiment of the stop light sensor of the present invention in accordance with the disclosed structure. The stop light sensor 100 includes a housing 201 which is waterproof and sealed to protect the electronic components of the sensor device 100. The housing 201 can be made in different shapes and designs to affix in the front grille of an automobile. The stop light sensor 100 includes a plurality of image sensors 202 to capture images of the traffic light which is part of the field of view (FoV) of the image sensors 202. Preferably, image sensors 202 have a wider FoV to capture the entire traffic light, including red, yellow, and green signals. Image sensors 202 may include wide-angle lenses which provide a broader FoV to provide accurate and precise detection of traffic lights. The FoV can be captured based on the applicable regulations of an area.

An image processor 204 includes image processing algorithms for analyzing the images of the traffic lights captured by the image sensors 202. It will be apparent to a person skilled in the art that the image sensors 202 capture real-time videos and images at an intersection or when the vehicle is stopped. The image processing algorithms detect the traffic light and transition of the traffic light emittance from red to green. The algorithms are trained to recognize the specific patterns and colors of traffic lights, with an emphasis on detecting the transition from red to green. For example, the image processor 204 can detect a green circle or arrow in the detected traffic light for alerting the driver of the automobile in which the driver alert device 100 can be installed.

A vehicle connection module 206 is included in the sensor device 100 for coupling the sensor device 100 with the onboard vehicular electronic control unit (ECU not shown). The connection module 206 can be either wired or wireless to meet the requirements of different automobile manufacturers. The connection module 206 allows the sensor device 100 to be coupled with the internal electric circuitry of the automobile through the ECU.

The sensor device 100 includes an embedded battery pack 208 which is both rechargeable and replaceable. The battery pack 208 provides electric power to the image sensors 202 and other electronic components. In some embodiments, the battery pack 208 can be recharged using solar energy and in other embodiments, the battery pack 208 can be recharged using the electric supply from the vehicle in which the sensor device 100 can be installed. A microprocessor 210 is included in the sensor device 100 for activating one or both of an audible notification and vibration notification when the transition from red light to green light is detected by the sensor device 100 as described in FIG. 3.

FIG. 3 illustrates a functional block diagram depicting the generation of the audible and vibration notification to alert a driver of a green traffic light in accordance with the disclosed structure. The automated traffic signal recognition and driver notification device 100 is coupled to a speaker 302 which is housed inside the vehicle in which the device 100 can be installed. Further, the device 100 is also coupled to a vibration module 304 installed in the driver seat of the vehicle. When the device 100 detects a transition from red to green light in a traffic signal light, the microprocessor 210 activates an audible notification through the speaker 302 and vibrates the driver seat using the vibration module 304. In some embodiments, only one notification can be activated as per requirements and preferences of a user.

It will be apparent to a person skilled in the art that the speaker 302 and the vibration sensor 304 can be pre-manufactured in the automobile and are coupled to the device 100 using the ECU. However, preferably the speaker 304 and the vibration sensor 304 are installed to work with the sensor device 100. In the present disclosure, the combination of the automated traffic signal recognition and driver notification device 100, speaker 302, and the vibration module 304 is referred to as automated traffic signal recognition and driver notification system 300 which can be integrated or retrofitted in an automobile. The device 100 can also be connected to the speakers 302 and the vibration module 304 through any other wired or wireless medium.

FIG. 4 illustrates a perspective view showing a field of view of the traffic signal recognition and driver notification device for detecting the transition from red to green light in accordance with the disclosed structure. As illustrated, the FoV 402 is vertical for detecting traffic lights 404. The FoV 402 of the image sensors of the device 100 encompass the area where the traffic lights are typically positioned and avoid blind spots where traffic lights may not be visible to the sensor device 100. The image sensors 202 included in the traffic signal recognition and driver notification device 100 are hi-def sensors and detect the traffic signals even in inclement weather conditions, dark light, and obstructions.

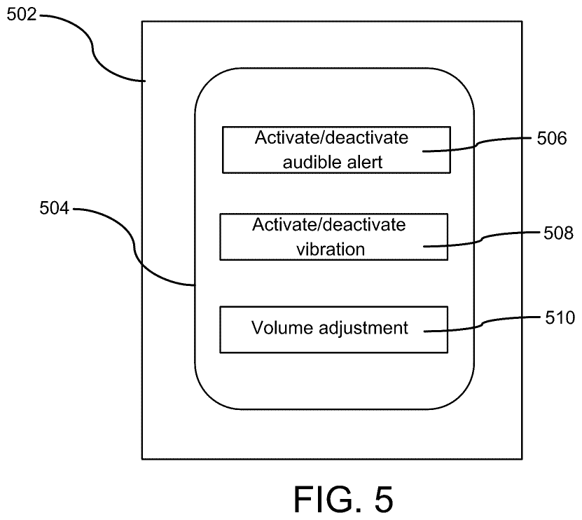

FIG. 5 illustrates an exemplary user interface of a monitoring device for controlling and configuring the automated traffic signal recognition and driver notification system 300 of the present invention in accordance with the disclosed architecture. The system 300 can be coupled with a controlling device 502 which can be in the form of a handheld user device or dashboard of the vehicle in which the driver alert system 300 can be installed. A user interface 504 displayed by the controlling device 502 allows a driver to configure different parameters of the functioning of the system 100. As illustrated, activate/deactivate audible alert option 506 allows a driver to selectively activate and deactivate the audible notification from the speaker. An activate/deactivate vibration option 508 allows the driver to selectively activate and deactivate the vibration signal generation from the device 100. A volume adjustment button 510 allows the driver to adjust the volume of the audible notification as per the preferences.

In some embodiments of the present invention, the device 100 is configured to detect a countdown timer associated with traffic lights. Upon detection of a countdown timer in the captured video or image, the device 100 counts the countdown timer for precisely alerting a driver upon transition from red signal to green signal.

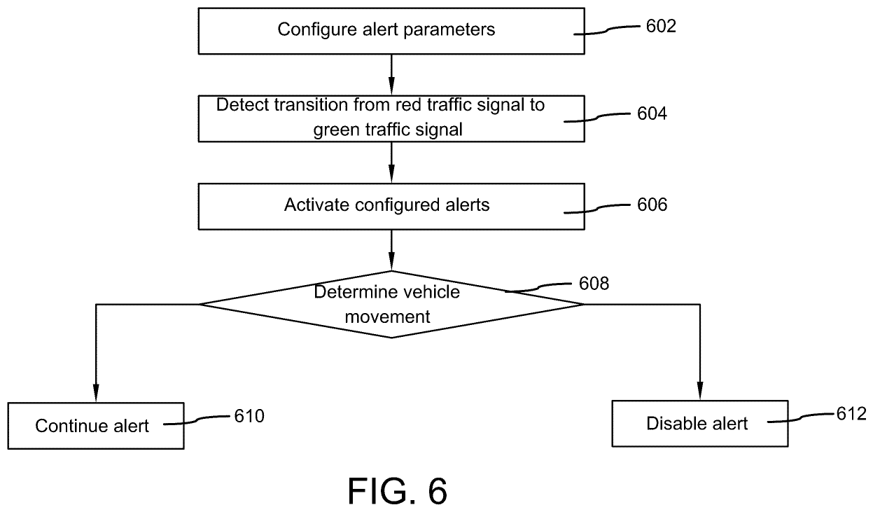

FIG. 6 illustrates a flow chart depicting a process of working of the system 300 and the device 100 to provide alerts to a driver in accordance with the disclosed architecture. Initially, alert parameters and configuration are set by a user using the controlling device 502 as described in FIG. 5 (Step 602). Then, the device 100 detects a transition from the red traffic signal to the green traffic signal (Step 604). Once, transition is detected, one or both of audible and vibration alerts are provided to the driver (Step 606). In the present embodiment, the device 100 detects a motion or movement of the vehicle in which the device 100 and the system 300 can be installed (Step 608). The movement is detected after detecting the transition of a traffic signal to a green color. When the movement is not detected, the alerts are continued to warn the driver of the green light (Step 610). In case the movement of the vehicle is detected, the alerts are deactivated (Step 612). In some embodiments, the alerts can be manually deactivated by a user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “driver alert device”, “stop light sensor”, “sensor device”, “automated traffic signal recognition and driver notification device”, and “traffic signal recognition device” are interchangeable and refer to the automated traffic signal recognition and driver notification device 100 of the present invention. Similarly, as used herein driver alert device”, “automated traffic signal recognition and driver notification system”, “driver alert system”, and “system” are interchangeable and refer to the automated traffic signal recognition and driver notification system 300 of the present invention.

Notwithstanding the foregoing, the automated traffic signal recognition and driver notification device 100 and the automated traffic signal recognition and driver notification system 300 of the present invention can be of any suitable size and configuration as is known in the art without affecting the overall concept of the invention, provided that they accomplish the above-stated objectives. One of ordinary skill in the art will appreciate that the automated traffic signal recognition and driver notification device 100 and the automated traffic signal recognition and driver notification system 300 as shown in the FIGS. is for illustrative purposes only, and that many other sizes and shapes of the automated traffic signal recognition and driver notification device 100 and the automated traffic signal recognition and driver notification system 300 are well within the scope of the present disclosure. Although the dimensions of the automated traffic signal recognition and driver notification device 100 and the automated traffic signal recognition and driver notification system 300 are important design parameters for user convenience, the automated traffic signal recognition and driver notification device 100 and the automated traffic signal recognition and driver notification system 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A stop light sensor for alerting to a traffic light, the stop light sensor comprising:
a housing including a plurality of light sensors to capture traffic light colors, an image processor to recognize traffic light colors, and at least one alert mechanism for alerting a driver to a light change;
wherein said plurality of light sensors integrated into a vehicle;
wherein said at least one alert selected from an audible notification and a vibration notification;
wherein said light change includes a change from a red light to a green light; and
further wherein said image processor detects a color change of light emitting from the red light and light emitting from the green light.

2. The stop light sensor of claim 1, wherein said vehicle is an automobile.

3. The stop light sensor of claim 2, wherein said audible notification having a speaker for emitting said audible notification.

4. The stop light sensor of claim 3, wherein said vibration notification having a vibration mechanism mounted to a driver's seat for emitting a vibration.

5. The stop light sensor of claim 4, wherein said integration includes retrofitting said plurality of light sensors into a front grille of the automobile after manufacturing of the automobile.

6. The stop light sensor of claim 4, wherein said integration includes installing said plurality of light sensors into a front grille of the automobile during manufacturing of the automobile.

7. The stop light sensor of claim 5, wherein said housing is waterproof.

8. The stop light sensor of claim 7, wherein each of said plurality of light sensors having a wide angle lens including a field of view (FoV) to capture the traffic light hanging over an intersection.

9. A stop light sensor for alerting to a traffic light, the stop light sensor comprising:
a housing including a plurality of light sensors to capture traffic light colors, an image processor to recognize traffic light colors, at least one alert mechanism for alerting a driver to a light change, and a vehicle connection module;
wherein said plurality of light sensors integrated into a vehicle;
wherein said at least one alert mechanism selected from an audible notification and a vibration notification;
wherein said light change includes a change from a red light to a green light;
wherein said vehicle connection module couples said stop light sensor with the vehicle ECU; and
further wherein said image processor detects a color change of light emitting from the red light and light emitting from the green light.

10. The stop light sensor of claim 9, wherein said stop light sensor having a battery for powering said plurality of light sensors.

11. The stop light sensor of claim 10, wherein said battery connected to the vehicle's electric supply and rechargeable from the vehicle's electric supply.

12. The stop light sensor of claim 9, wherein both of said audible notification and said vibration notification actuated when said image processor detects the color change of light emitting from the red light and light emitting from the green light.

13. The stop light sensor of claim 12, wherein said audible notification having a speaker for emitting said audible notification.

14. The stop light sensor of claim 13, wherein said vibration notification having a vibration mechanism mounted to a driver's seat for emitting a vibration.

15. The stop light sensor of claim 14, wherein each of said plurality of light sensors having a wide angle lens including a field of view (FoV) to capture the traffic light hanging over an intersection.

16. A method for alerting a driver to a traffic light change, the method comprising the steps of:
providing a stop light sensor having a housing including a plurality of light sensors to capture traffic light colors, an image processor to recognize traffic light colors, at least one alert mechanism for alerting a driver to a light change, and a vehicle connection module, wherein said plurality of light sensors integrated into a vehicle and further wherein said light change includes a change from a red light to a green light;
selecting at least one alert mechanism from an audible notification and a vibration notification;
coupling said vehicle connection module with said stop light sensor and the vehicle ECU;
detecting with said image processor a color change of light emitting from the red light and light emitting from the green light; and
actuating at least one alert mechanism when detecting the color change from the red light to the green light.

17. The method for alerting a driver to a traffic light change of claim 16 further comprising a step of actuating both of said audible notification and said vibration notification when said image processor detects the color change of light emitting from the red light and light emitting from the green light.

18. The method for alerting a driver to a traffic light change of claim 16, wherein said audible notification having a speaker for emitting said audible notification.

19. The method for alerting a driver to a traffic light change of claim 16, wherein said vibration notification having a vibration mechanism mounted to a driver's seat for emitting a vibration.

20. The method for alerting a driver to a traffic light change of claim 16 further comprising the steps of:
detecting movement of the vehicle; and
deactivating said at least one alert mechanism upon detection of motion of the vehicle.
